(19) United States
(12) Patent Application Publication
(10) Pub. No.: US 2020/0199004 A1
(43) Pub. Date: Jun. 25, 2020

(54) ENCLOSURES FOR GLASS FORMING APPARATUSES

(71) Applicant: CORNING INCORPORATED, CORNING, NY (US)

(72) Inventors: Robert Delia, Horseheads, NY (US); Bulent Kocatulum, Horseheads, NY (US); Timothy L Lansberry, Watkins Glen, NY (US); Michael Yoshiya Nishimoto, Horseheads, NY (US); Justin Shane Starkey, Painted Post, NY (US); Jae Hyun Yu, Big Flats, NY (US)

(21) Appl. No.: 16/634,735

(22) PCT Filed: Sep. 24, 2018
(86) PCT No.: PCT/US18/46592

§ 371 Date: Jan. 28, 2020

Related U.S. Application Data
(60) Provisional application No. 62/546,582, filed on Aug. 17, 2017.

(51) Int. Cl. C03B 17/06

(52) U.S. Cl. CPC C03B 17/064

(57) ABSTRACT

A forming body enclosure may include a top panel and a pair of side panels. Each of the pair of side panels of the enclosure may include a plurality of cradle joints extending along a length of the forming body, a plurality of bottom row tiles and a plurality of top row tiles. The plurality the plurality of top row tiles are positioned above the plurality of bottom row tiles with at least one of the plurality of cradle joints positioned between the plurality of bottom row tiles and plurality of top row tiles. The plurality of top row tiles and the plurality of bottom row tiles are seated within the plurality of cradle joints to form each of the pair of side panels.

### CROSS-REFERENCE TO RELATED APPLICATIONS

This application claims the benefit of priority of U.S. Provisional Application Ser. No. 62/546,582 filed on Aug. 17, 2017 the contents of which are relied upon and incorporated herein by reference in their entirety as if fully set forth below.

### BACKGROUND

### Field

The present specification generally relates to glass forming apparatuses and, more specifically, to enclosures for forming bodies of glass forming apparatuses.

### Technical Background

The fusion process is one technique for forming continuous glass ribbons. Compared to other processes for forming glass ribbons, such as the float and slot-draw processes, the fusion process produces glass ribbons with a relatively low amount of defects and with surfaces having superior flatness. As a result, the fusion process is widely employed for the production of glass substrates that are used in the manufacture of LED and LCD displays and other substrates that require superior flatness and smoothness.

In the fusion process, molten glass is fed into a forming body with a trough that receives the molten glass and a pair of forming surfaces that converge along a bottom edge (e.g., “root”). The molten glass evenly flows out of the trough, over the forming surfaces and forms a glass ribbon of flat glass with pristine surfaces drawn from the root of the forming body. The forming body is generally positioned within an enclosure with a pair of side panels (side panels) and a top panel. The enclosure is designed to prevent contamination of molten glass in the trough and flowing over the forming surfaces. The enclosure may also assist in the thermal management of the forming body and molten glass during a glass ribbon forming campaign.

The demand and use of personal electronic devices continues to increase. Accordingly, the demand for glass substrates used to manufacture LED and LCD displays has also increased. One approach to meet the increased demand of such glass substrates is to increase the size and, hence, the production capability of forming bodies. As a result, enclosures for the forming bodies may also increase in size, as will the size (length and height), thickness and weight of refractory tiles used to form the enclosure.

Accordingly, a need exists for alternative forming body enclosures that can be scaled to accommodate larger forming bodies.

### SUMMARY

According to one embodiment, a glass forming apparatus may include a forming body and an enclosure positioned around the forming body. The enclosure may include a top panel and a pair of side panels. Each of the side panels comprises a plurality of cradle joints, a plurality of bottom row tiles and a plurality of top row tile. The plurality of cradle joints extend along a length of the forming body. The plurality of top row tiles are positioned above the plurality of bottom row tiles with at least one of the plurality of cradle joints positioned between the plurality of bottom row tiles and plurality of top row tiles. The plurality of top row tiles and the plurality of bottom row tiles are engaged with the at least one of the plurality of cradle joints to form each of the pair of side panels. The plurality of cradle joints may include a bottom cradle joint, an intermediate cradle joint and a top cradle joint with the intermediate cradle joint spaced apart from and positioned above the bottom cradle joint, and the top cradle joint spaced apart from and positioned above the intermediate cradle joint. The plurality of bottom row tiles extend between the bottom cradle joint and intermediate cradle joint, and the plurality of top row tiles extend between the intermediate cradle joint and the top cradle joint. A bottom edge portion and a top edge portion of each of the plurality of bottom row tiles is seated within the bottom cradle joint and intermediate cradle joint, respectively, and a bottom edge portion and a top edge portion of each of the plurality of top row tiles is seated within the intermediate cradle joint and top cradle joint, respectively.

According to another embodiment, an enclosure for a glass forming apparatus may include a pair of side panels and a top panel extending between the pair of side panels. Each of the side panels may include a bottom cradle joint, an intermediate cradle joint and a top cradle joint. The intermediate cradle joint is spaced apart from and positioned above the bottom cradle joint, and the top cradle joint is spaced apart from and positioned above the intermediate cradle joint. A plurality of bottom row tiles extend between the bottom cradle joint and intermediate cradle joint, and a plurality of top row tiles extending between the intermediate cradle joint and the top cradle joint. In embodiments, the bottom cradle joint comprises a U-shaped elongated member with an upper facing channel, the intermediate cradle joint comprises an H-shaped elongated member with a lower facing channel and an upper facing channel, and the top cradle joint comprises an h-shaped elongated member with a lower facing channel. A bottom edge portion of each of the plurality of bottom row tiles may be seated within the upper facing channel of the bottom cradle joint. A top edge portion of each of the plurality of bottom row tiles may be seated within the lower facing channel of the intermediate cradle joint. A bottom edge portion of each of the plurality of top row tiles may be seated within the upper facing channel of the intermediate cradle joint. A top edge portion of each of the plurality of top row tiles may seated within the lower facing channel of the top cradle joint. Adjacent side edges of the plurality of bottom row tiles and the plurality of top row tiles may comprise a convex-concave overlapping joint.

Additional features and advantages of the glass forming apparatuses described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein and together with the description serve to explain the principles and operations of the claimed subject matter.

### BRIEF DESCRIPTION OF THE DRAWINGS

FIG. 1 schematically depicts a glass forming apparatus according to one or more embodiments shown and described herein;

FIG. 2A schematically depicts a side view of a forming body according to one or more embodiments shown and described herein;

FIG. 2B schematically depicts a cross section of the forming body of FIG. 2A;

FIG. 3 schematically depicts a perspective view of the forming body of FIG. 2A positioned within an enclosure;

FIG. 4 schematically depicts a side view of a forming body positioned within an enclosure according to one or more embodiments shown and described herein;

FIG. 5 schematically depicts a side view of FIG. 3 without the forming body positioned within the enclosure;

FIG. 6 schematically depicts a cross section of the enclosure of FIG. 5;

FIG. 7 schematically depicts an exploded view of a side panel in FIG. 5;

FIG. 8 schematically depicts a cross section of an intermediate cradle joint according to one or more embodiments shown and described herein;

FIG. 9 schematically depicts an exploded view of the intermediate cradle joint in FIG. 8;

FIG. 10 schematically depicts a cross section of adjacent side panel tiles for the enclosure of FIG. 5;

FIG. 11 schematically depicts a top view of a top panel of the enclosure of FIG. 5;

FIG. 12 schematically depicts a cross-section of adjacent top panel tiles for the top panel of FIG. 9;

FIG. 13 schematically depicts a cross-section of a distal end panel of the enclosure 5;

FIG. 14 schematically depicts the cross section of FIG. 6 with an intermediate support according to one or more embodiments shown and described herein;

FIG. 15 schematically depicts the forming body and enclosure of FIG. 4 with an array of thermal elements positioned above the enclosure according to one or more embodiments shown and described herein;

FIG. 16 schematically depicts the forming body and enclosure of FIG. 4 with an array of thermal elements positioned above the enclosure according to one or more embodiments shown and described herein; and

FIG. 17 schematically depicts the forming body and enclosure of FIG. 4 with a glow bar positioned over the enclosure according to one or more embodiments shown and described herein.

### DETAILED DESCRIPTION

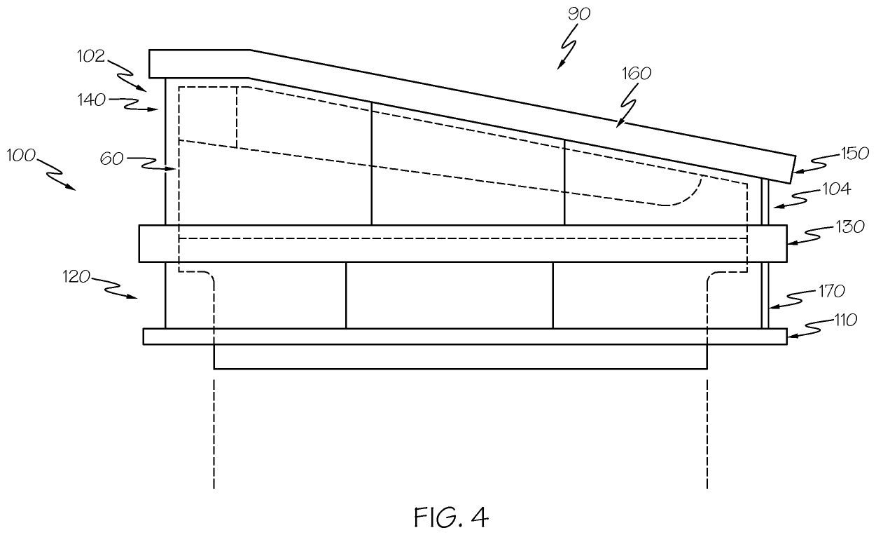

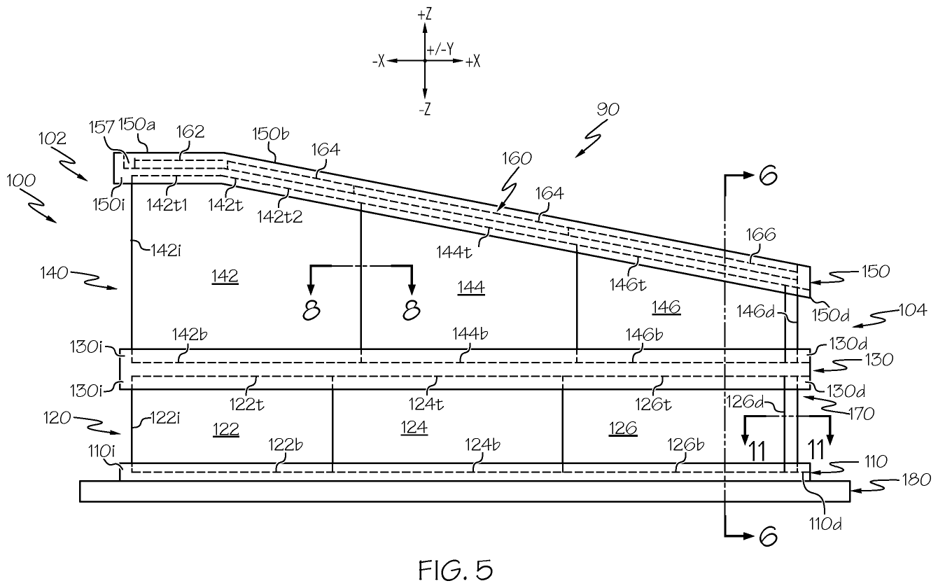

Reference will now be made in detail to embodiments of enclosures for glass forming apparatuses and glass forming apparatuses comprising the same, examples of which are illustrated in the accompanying drawings. Whenever possible, the same reference numerals will be used throughout the drawings to refer to the same or like parts. One embodiment of a glass forming apparatus is schematically depicted in FIGS. 4 and 5. The glass forming apparatus may include a forming body and an enclosure positioned around the forming body. The enclosure may include a top panel and a pair of side panels. Each side panel includes a plurality of cradle joints, a plurality of bottom row tiles and a plurality of top row tiles. The plurality of cradle joints extend along a length of the forming body and the plurality of top row tiles are positioned above the plurality of bottom row tiles with at least one of the plurality of cradle joints positioned between the plurality of bottom row tiles and the plurality of top row tiles. The plurality of top row tiles and the plurality of bottom row tiles are engaged with at least one of the plurality of cradle joints to form each of the pair of side panels. Various examples of enclosures for glass forming apparatuses and glass forming apparatuses comprising the same will be described in further detail with specific reference to the appended drawings.

Directional terms as used herein—for example up, upper, upward, down, downward, lower, right, left, front, back, top, bottom, above, below—are made only with reference to the figures as drawn and are not intended to imply absolute orientation.

Unless otherwise expressly stated, it is in no way intended that any method set forth herein be construed as requiring that its steps be performed in a specific order, nor that any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise. As used herein, the term “seated” refers to one member positioned within and having continuous surface engagement with another member.

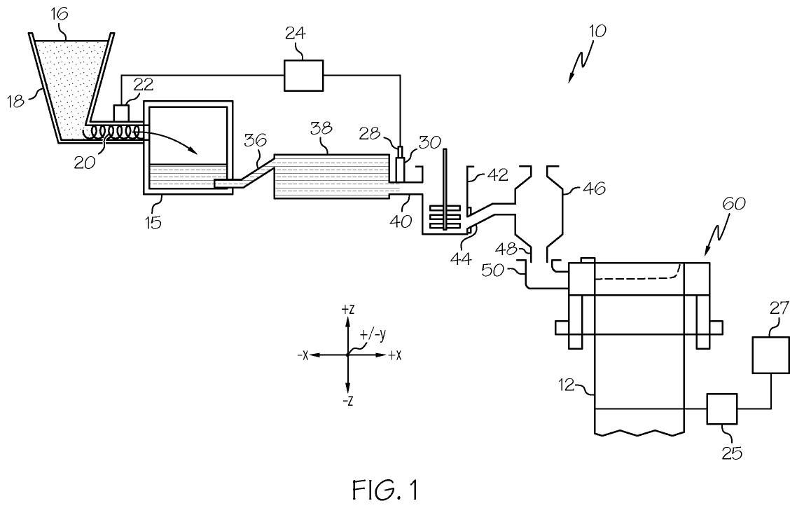

Referring now to FIG. 1, a glass forming apparatus 10 for making glass articles, such as a glass ribbon 12, is schematically depicted. The glass forming apparatus 10 may generally include a melting vessel 15 configured to receive batch material 16 from a storage bin 18. The batch material 16 can be introduced to the melting vessel 15 by a batch delivery device 20 powered by a motor 22. An optional controller 24 may be provided to activate the motor 22 and a molten glass level probe 28 can be used to measure the glass melt level within a standpipe 30 and communicate the measured information to the controller 24.

The glass forming apparatus 10 can also include a fining vessel 38, such as a fining tube, coupled to the melting vessel 15 by way of a first connecting tube 36. A mixing vessel 42 is coupled to the fining vessel 38 with a second connecting tube 40. A delivery vessel 46 is coupled to the mixing vessel 42 with a delivery conduit 44. A downcomer 48 is positioned to deliver glass melt from the delivery vessel 46 to an inlet end 50 of a forming body 60. In the embodiments shown and described herein, the forming body 60.

The melting vessel 15 is typically made from a refractory material, such as refractory (e.g., ceramic) brick. The glass forming apparatus 10 may further include components that are typically made from electrically conductive refractory metals such as, for example, platinum or platinum-containing metals such as platinum-rhodium, platinum-iridium and combinations thereof. Such refractory metals may also include molybdenum, palladium, rhenium, tantalum, titanium, tungsten, ruthenium, osmium, zirconium, and alloys thereof and/or zirconium dioxide. The electrically conductive refractory metal containing components can include one or more of the first connecting tube 36, the fining vessel 38, the second connecting tube 40, the standpipe 30, the mixing vessel 42, the delivery conduit 44, the delivery vessel 46, the downcomer 48 and the inlet end 50.

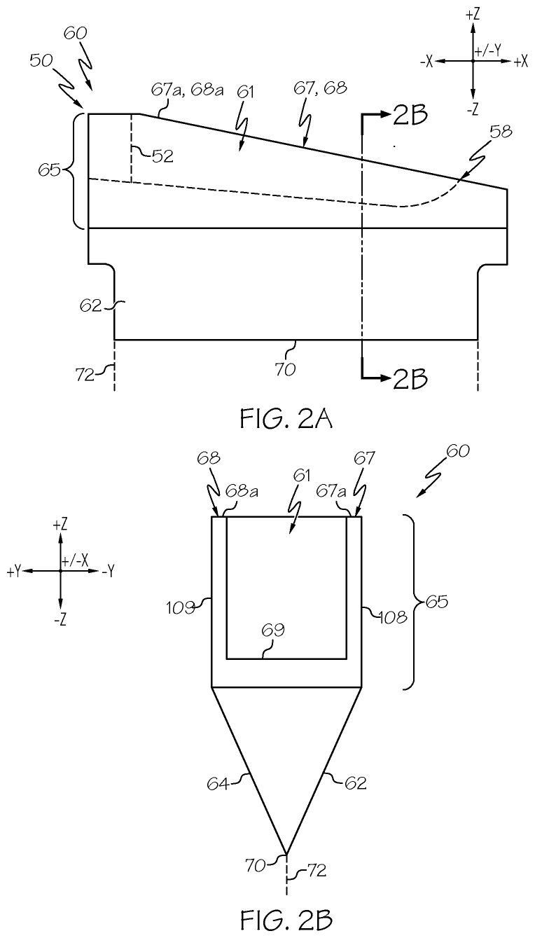

Referring now to FIGS. 1-2B, the forming body 60 comprises a trough 61 with an inlet end 52 and a distal end 58 opposite the inlet end 52. As used herein, the “distal” end of an element of the forming body 60 refers to a downstream end of the element (relative to an upstream, or “inlet” end of the element). The trough 61 is located in an upper portion 65 of the forming body 60 and comprises a first weir 67 with a top surface 67a and an outer vertical surface 108, a second weir 68 with a top surface 68a and an outer vertical surface 109, and a base 69. The top surface 67a and top surface 68a extend along a length L of the forming body 60 and may lie in a single plane. In embodiments, the top surfaces 67a, 68a lie within a horizontal plane, i.e., the top surfaces 67a, 68a lie within the X-Y plane depicted in the figures. In other embodiments, the top surfaces 67a, 68a lie within a plane that is not horizontal, i.e., the top surfaces 67a, 68a do not lie within the X-Y plane depicted in the figures. In still other embodiments, the top surfaces lie in two separate planes, e.g., one portion or length of the top surfaces 67a, 68a lie within a horizontal plane and another portion or length of the top surfaces 67a, 68a do not lie within the horizontal plane. The trough 61 may vary in depth as a function of length along the forming body. The forming body 60 may further comprise a first forming surface 62 and a second forming surface 64. The first forming surface 62 and the second forming surface 64 extend from the upper portion 65 of the forming body 60 in a vertically downward direction (i.e., the −Z direction of the coordinate axes depicted in the figures) and converge towards one another, joining at a lower (bottom) edge of the forming body 60, which may also be referred to as the root 70. Accordingly, it should be understood that the first forming surface 62 and the second forming surface 64 form an inverted isosceles (or equilateral) triangle extending from the upper portion 65 of the forming body 60 with the root 70 forming the lower-most vertex of the triangle in the downstream direction. A draw plane 72 generally bisects the forming body 60 at the root 70 in the +/−Y directions of the coordinate axes depicted in the figures and extends in the vertically downward direction (−Z direction), although in further embodiments, the draw plane may extend at other orientations.

Still referring to FIGS. 1-2B, in operation, batch material 16, specifically batch material for forming glass, is fed from the storage bin 18 into the melting vessel 15 with the batch delivery device 20. The batch material 16 is melted into molten glass in the melting vessel 15. The molten glass passes from the melting vessel 15 into the fining vessel 38 through the first connecting tube 36. Dissolved gasses, which may result in glass defects, are removed from the molten glass in the fining vessel 38. The molten glass then passes from the fining vessel 38 into the mixing vessel 42 through the second connecting tube 40. The mixing vessel 42 homogenizes the molten glass, such as by stirring, and the homogenized molten glass passes through the delivery conduit 44 to the delivery vessel 46. The delivery vessel 46 discharges the homogenized molten glass through downcomer 48 and into the inlet end 50 of the forming body 60, which in turn passes the homogenized molten glass into the trough 61 of the forming body 60 toward the distal end 58 of the trough 61.

The homogenized molten glass fills the trough 61 of the forming body 60 and ultimately overflows, flowing over the first weir 67 and second weir 68 of the upper portion 65 of the forming body 60 along at least a portion of its length L and then in the vertically downward direction (−Z direction). The homogenized molten glass flows from the upper portion 65 of the forming body 60 and onto the first forming surface 62 and the second forming surface 64. Streams of homogenized molten glass flowing over the first forming surface 62 and the second forming surface 64 join and fuse together at the root 70, forming a glass ribbon 12 that is drawn on the draw plane 72 in the downstream direction by pulling rolls (not shown). A thickness measurement device 25 measures the thickness of the glass ribbon 12 along the width (+/−X direction) of the glass ribbon 12. Thickness measurement values of the glass ribbon 12 along its width may be transmitted to a controller 27 and the controller 27 may adjust localized heating or cooling of molten glass flowing over the first weir 67 and second weir 68 as discussed in greater detail herein. The glass ribbon 12 may be further processed downstream of the forming body 60 such as by segmenting the glass ribbon 12 into discrete glass sheets, rolling the glass ribbon 12 upon itself, and/or applying one or more coatings to the glass ribbon 12.

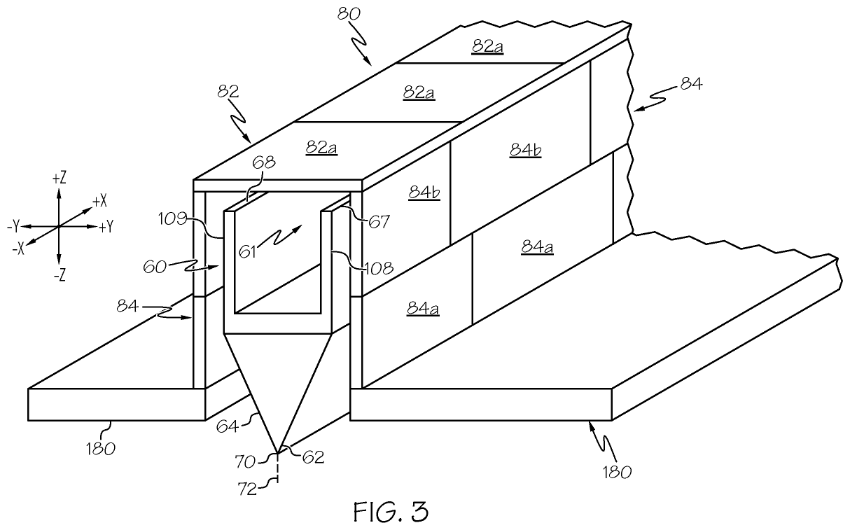

Referring now to FIG. 3, the forming body 60 is typically positioned within an enclosure 80. The enclosure is designed to prevent contamination of molten glass in the trough 61 and flowing down the outer vertical surfaces 108, 109 from debris, dust, etc., and may assist in the thermal management of the forming body 60 and molten glass flowing into and over the forming body. The enclosure 80 includes a top panel 82 that extends over and across the trough 61 and a pair of side panels 84 that extend down (−Z direction) from the top panel 82 adjacent the outer vertical surfaces of the 110, 112 of the forming body 60. The top panel 82 is formed from a plurality of top panel tiles 82a and the side panels 84 are formed from a plurality of bottom row tiles 84a and top row tiles 84b. The bottom row tiles 84a are typically positioned on and supported by a base support 180. Thermal elements (not shown) used for thermal management of the forming body 60 and molten glass flowing into and over the forming body may be positioned above (+Z direction) the top panel 82 and/or adjacent the side panels 84. Heating or cooling provided by the thermal elements may result in thermal gradients along the length (X-direction), height (Z-direction) and thickness (Y-direction) of the tiles 82a, 84a, 84b. Also, as the size and thickness of top panel 82 and side panels 84 increases to accommodate larger forming bodies, as noted above, a corresponding increase in the propensity of the tiles to crack also occurs. Cracking of the tiles may cause discontinues in the thermal environment within the enclosure 80, which in turn may lead to process inefficiencies as glass ribbon that is out of specification due to thermal discontinuities is discarded.

The embodiments of the enclosures and glass forming apparatuses comprising the enclosures described herein provide an enclosure for a forming body that reduces thermally induced strain within the tiles of the enclosure and thermally induced stress between adjacent tiles, and provide for enhanced thermal control of molten glass flowing from a trough and down forming surfaces of a forming body.

Referring now to FIG. 4, an enclosure 90 with a forming body 60 positioned therein includes a pair of side panels 100 (only one shown), a top panel 160, and a distal end panel 170. The side panel 100 has an inlet end 102, a distal end 104 and a plurality of cradle joints extending between the inlet end 102 and distal end 104. For example, the side panel 100 may include a bottom cradle joint 110, an intermediate cradle joint 130, and a top cradle joint 150. The intermediate cradle joint 130 is spaced apart and positioned above (+Z direction) the bottom cradle joint 110 and the top cradle joint 150 is spaced apart and positioned above the intermediate cradle joint 130. Positioned between the bottom cradle joint 110 and the intermediate cradle joint 130 is a plurality of bottom row tiles 120. Positioned between the intermediate cradle joint 130 and the top cradle joint 150 is a plurality of top row tiles 140. Accordingly, a given side panel 100 of the enclosure may include a bottom cradle joint 110, an intermediate cradle joint 130, a top cradle joint 150, a plurality of bottom row tiles 120 between the bottom cradle joint 110 and intermediate cradle joint 130, and a plurality of top row tiles 140 between the intermediate cradle joint 130 and top cradle joint 150.

Referring now to FIG. 5 the enclosure 90 is shown without the forming body 60 positioned within the enclosure 90. The plurality of bottom row tiles 120 may include an inlet end tile 122 and a distal end tile 126. Between the inlet end tile 122 and distal end tile 126 may be at least one middle tile 124. The inlet end tile 122 has a bottom edge portion 122b seated within the bottom cradle joint 110 and a top edge portion 122t seated within the intermediate cradle joint 130. Similarly, the at least one middle tile 124 and the distal end tile 126 have bottom edge portions 124b, 126b, respectively, seated within the bottom cradle joint 110 and a top edge portion 124t, 126t, respectively, seated within the intermediate cradle joint 130.

The plurality of top row tiles 140 includes an inlet end tile 142 and a distal end tile 146. Positioned between the inlet end tile 142 and the distal end tile 146 may be at least one middle tile 144. The inlet end tile 142 has a bottom edge portion 142b seated within the intermediate cradle joint 130 and a top edge portion 142t seated within the top cradle joint 150. Similarly, the at least one middle tile 144 and the distal end tile 146 have bottom edge portions 144b, 146b, respectively, seated within the intermediate cradle joint 130 and top edge portions 144t, 146t, respectively, seated within the top cradle joint 150. In embodiments, the top edge portion 142t of the inlet end tile 142 has a first portion 142t₁ that is generally horizontal (X axis) and a second portion 142t₂ that extends at an incline from the first portion 142t₁. In such embodiments, the top cradle joint 150 may have a first portion 150a that is generally horizontal and a second portion 150b that extends at an angle relative to horizontal from the first portion 150a. It should be understood that the second portion 142t₂ of the top edge portion 142t and the second portion 150b of the top cradle joint 150 are complementary with each other such that the second portion 142t₂ and second portion 150b extend at the same angle from horizontal as depicted in FIG. 5. Also, it should be understood that the top edge portions 144t, 146t of the middle tile 144 and distal end tile 146, respectively, extend at an angle and are parallel with the second portion 150b of the top cradle joint 150.

The top panel 160 (shown in dashed lines) may include an inlet end tile 162, a distal end tile 166 and at least one middle tile 164 (collectively referred to herein as “top panel tiles 162, 164, 166”). The top panel tiles 162, 164, 166 are positioned on and supported by the top cradle joint 150 as discussed in greater detail herein. The inlet end tile 162 extends generally horizontal (X-axis) and is parallel with the first portion 150a of the top cradle joint 150. The at least one middle tile 164 and distal end tile 166 extend at an angle relative to horizontal and are parallel with the second portion 150b of the top cradle joint 150. Although FIG. 5 depicts the top cradle joint 150 with a horizontal portion (first portion 150a) and an incline portion (second portion 150b), it should be understood that enclosures with a top cradle joint 150 and top panel 160 having a single linear profile along the length L direction (X-direction) of the forming body 60 are contemplated and possible.

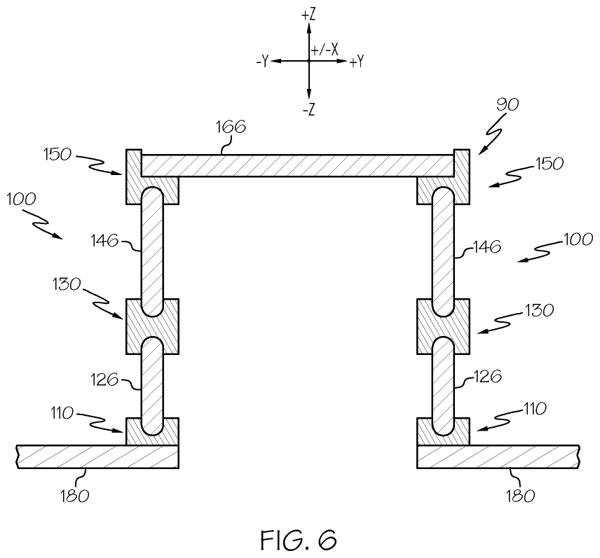

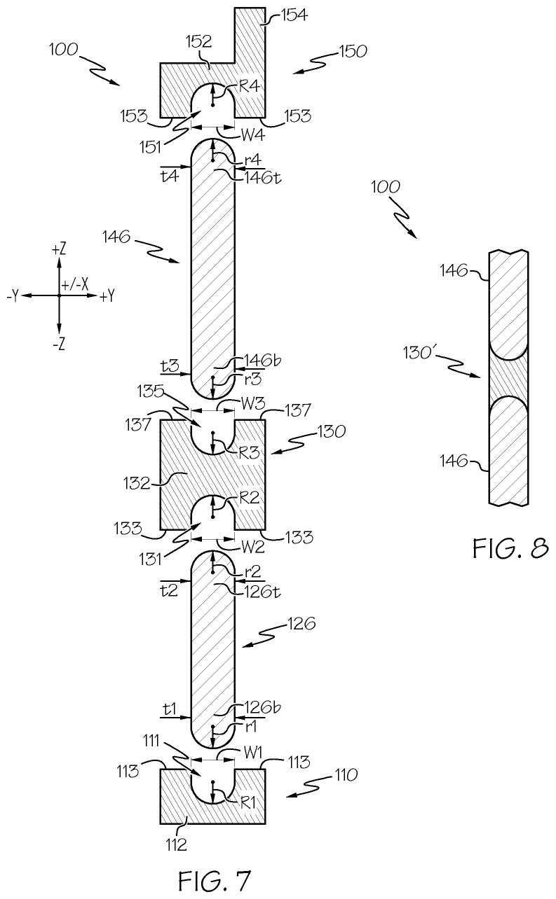

Referring now to FIGS. 6 and 7, an end view of section 6-6 in FIG. 5 is shown in FIG. 6 and an exploded view of one of the side panels 100 is shown in FIG. 7. The bottom cradle joint 110 may be a U-shaped (in cross-section) elongated member with an upper facing channel 111 formed from a pair of spaced apart walls 113 extending from a base 112. The upper facing channel 111 may have a radius R1, and a width W1 between the pair of spaced apart walls 113 may be equal to 2·R1, less than 2·R1 or greater than 2·R1. The bottom edge portion 126b of the distal end tile 126 has a thickness tl that allows the bottom edge portion 126b to be seated within the upper facing channel 111 of the bottom cradle joint 110. In embodiments, the thickness tl is generally equal to the width W1. In other embodiments, the thickness tl is less than the width W1 and the bottom edge portion 126b is seated within the upper facing channel 111 with clearance (space) between the pair of spaced apart walls 113 and the distal end tile 126. It should be understood that the bottom edge portions 122b, 124b of the inlet end tile 122 and middle tile 124, respectively, may have the thickness tl that allows the bottom edge portions 122b, 124b to be seated within the upper facing channel 111 of the bottom cradle joint 110 as discussed with reference to the bottom edge portion 126b of the distal end tile 126.

In embodiments, the bottom edge portion 126b may have an arcuate bottom edge that is complementary with the upper facing channel 111 such that a sharp or discontinuous edge (e.g., a corner) is not present between the distal end tile 126 and the bottom cradle joint 110. For example, the bottom edge portion 126b may have a radius rl such that a smooth surface engagement between the bottom edge portion 126b and the upper facing channel 111 is provided and points or areas of high stress concentration between the bottom edge portion 126b and the upper facing channel 111 are avoided. As used herein, the term stress concentration refers to localized stress within an object or between objects that is significantly higher (e.g., >50%) than an average stress between the two objects due to an abrupt change in geometry within the object or between the two objects. The magnitude of stress concentration at a location with an abrupt change in geometry (e.g., a corner) is typically expressed by a stress concentration factor K defined as σₘₐₓ/σₐᵥₑ where σₘₐₓ is the stress at the location of the abrupt change in geometry (e.g., the corner) and Gave is the average stress across an entire cross-section of the object. Also, σₘₐₓ is inversely proportional to the radius of a corner such that as the radius of the corner decreases the stress concentration factor K, and thus the stress concentration at the corner increases. In some embodiments, radius r1 of the bottom edge portion 126b is generally equal to radius R1 of the upper facing channel 111, while in other embodiments radius r1 of the bottom edge portion 126b is less than radius R1 of the upper facing channel 111. It should be understood that the bottom edge portions 122b, 124b of the inlet end tile 122 and middle tile 124, respectively, may have a radius rl that is equal to radius R1 of the upper facing channel 111, or in the alternative, is less than radius R1.

Still referring FIGS. 6 and 7, the intermediate cradle joint 130 may be an H-shaped (in cross-section) elongated member with a lower facing channel 131 formed from a pair of spaced apart walls 133 extending from a base 132 and an upper facing channel 135 formed by a pair of spaced apart walls 137 extending from the base 132. The lower facing channel 131 may have a radius R2 and a width W2 between the pair of spaced apart walls 133 may be equal to 2·R2, less than 2·R2 or greater than 2·R2. The top edge portion 126t of the distal end tile 126 has a thickness t2 that allows the top edge portion 126t to be seated within the lower facing channel 131 of the intermediate cradle joint 130. In embodiments, the thickness t2 is generally equal to the width W2. In other embodiments, the thickness t2 is less than the width W2 and the top edge portion 126t is seated within the lower facing channel 131 with clearance between the pair of spaced apart walls 133 and the distal end tile 126. It should be understood that the top edge portions 122t, 124t of the inlet end tile 122 and middle tile 124, respectively, may have the thickness t2 that allows the top edge portions 122t, 124t to be seated within the upper facing channel 135 of the intermediate cradle joint 130 as discussed with reference to the top edge portion 126t of the distal end tile 126. In some embodiments, the thickness t2 is equal to the thickness tl, while in other embodiments the thickness t2 is less than the thickness tl such that the tiles 122, 124, 146 have a bottom edge portion 122b, 124b, 126b, respectively, that is thicker than a top edge portion 122t, 124t, 126t, respectively. In still other embodiments, the thickness t2 is greater than the thickness tl such that the tiles 122, 124, 146 have a top edge portion 122t, 124t, 126t, respectively, that is thicker than a bottom edge portion 122b, 124b, 126b, respectively.

The top edge portion 126t may have an arcuate top edge that is complementary with the lower facing channel 131 such that a sharp or discontinuous edge (e.g., a corner) is not present between the distal end tile 126 and the intermediate cradle joint 130. For example, the top edge portion 126t may have a radius r2 such that a continuous surface engagement between the top edge portion 126t and the lower facing channel 131 is provided as depicted in FIG. 6. In some embodiments, radius r2 of the top edge portion 126t is generally equal to radius R2 of the lower facing channel 131, while in other embodiments radius r2 of the top edge portion 126t is less than radius R2 of the lower facing channel 131. It should be understood that the top edge portions 122t, 124t of the inlet end tile 122 and middle tile 124, respectively, may have radius r2 that is equal to radius R2 of the lower facing channel 131, or in the alternative, is less than radius R2.

As noted above, the intermediate cradle joint 130 may have an upper facing channel 135. The upper facing channel 135 may have a radius R3 and a width W3 between the pair of spaced apart walls 137 may be equal to 2·R3 or greater than 2·R3. The bottom edge portion 146b of the distal end tile 146 has a thickness t3 that allows the bottom edge portion 146b to be seated within the upper facing channel 135 of the intermediate cradle joint 130. In embodiments, the thickness t3 is generally equal to the width W3. In other embodiments, the thickness t3 is less than the width W3 and the bottom edge portion 146b is seated within the upper facing channel 135 with clearance provided between the pair of spaced apart walls 137 and the distal end tile 146. It should be understood that the bottom edge portions 142b, 144b of the inlet end tile 142 and middle tile 144, respectively, may have the thickness t3 that allows the bottom edge portions 142b, 144b to be seated within the upper facing channel 135 of the intermediate cradle joint 130 as discussed with reference to the bottom edge portion 146b of the distal end tile 146.

The bottom edge portion 146b may have an arcuate bottom edge that is complementary with the upper facing channel 135 such that a sharp or discontinuous edge (e.g., a corner) is not present between the distal end tile 146 and the intermediate cradle joint 130. For example, the bottom edge portion 146b may have a radius r3 such that a continuous surface engagement between the bottom edge portion 146b and the upper facing channel 135 is provided as depicted in FIG. 6. In some embodiments, radius r3 of the bottom edge portion 146b is generally equal to radius R3 of the upper facing channel 135, while in other embodiments radius r3 of the bottom edge portion 146b is less than radius R3 of the upper facing channel 135. It should be understood that the bottom edge portions 142b, 144b of the inlet end tile 142 and middle tile 144, respectively, may have radius r3 that is equal to radius R3 of the upper facing channel 135, or in the alternative, is less than radius R3.

In embodiments, the intermediate cradle joint 130 may provide a thermal separator between the plurality of bottom row tiles 120 and the plurality of top row tiles 140. That is, the intermediate cradle joint 130 physically and thermally separates the plurality of bottom row tiles 120 and the plurality of top row tiles 140. In such embodiments, the intermediate cradle joint 130 may be formed from a material that is different than a material from which the plurality of bottom row tiles 120 and/or the plurality of top row tiles 140 are formed. In some embodiments, the intermediate cradle joint 130 is formed from a material with a thermal conductivity that is greater than a thermal conductivity of the plurality of bottom row tiles 120 and/or a thermal conductivity of the plurality of top row tiles 140. In other embodiments, the intermediate cradle joint 130 is formed from a material with a thermal conductivity that is less than a thermal conductivity of the plurality of bottom row tiles 120 and/or a thermal conductivity of the plurality of top row tiles 140.

Still referring to FIGS. 6 and 7, the top cradle joint 150 may be an h-shaped (in cross- section) elongated member with a lower facing channel 151 formed from a pair of spaced apart walls 153 extending downwardly (−Z direction) and an outer wall 154 extending upwardly (+Z direction). The lower facing channel 151 may have a radius R4 and a width W4 between the pair of spaced apart walls 153 may be equal to 2·R4, less than 2·R4 or greater than 2·R4. The top edge portion 146t of the distal end tile 146 has a thickness t4 that allows the top edge portion 146t to be seated within the lower facing channel 151 of the top cradle joint 150. In embodiments, the thickness t4 is generally equal to the width W4. In other embodiments, the thickness t4 is less than the width W4 and the top edge portion 146t is seated within the lower facing channel 151 with clearance provided between the pair of spaced apart walls 153 and the distal end tile 146. It should be understood that the top edge portions 142t, 144t of the inlet end tile 142 and middle tile 144, respectively, may have the thickness t4 that allows the top edge portions 142t, 144t to be seated within the lower facing channel 151 of the top cradle joint 150 as discussed with reference to the top edge portion 146t of the distal end tile 146. In some embodiments, the thickness t4 is equal to the thickness t3, while in other embodiments the thickness t4 is less than the thickness t3 such that the tiles 142, 144, 146 have a bottom edge portion 142b, 144b, 146b, respectively, that is thicker than a top edge portion 142t, 144t, 146t, respectively. In still other embodiments, the thickness t4 is greater than the thickness t3 such that the tiles 142, 144, 146 have a top edge portion 142t, 144t, 146t, respectively, that is thicker than a bottom edge portion 142b, 144b, 146b, respectively.

The top edge portion 146t may have an arcuate top edge that is complementary with the lower facing channel 151 such that a sharp or discontinuous edge (e.g., a corner) is not present between the distal end tile 146 and the top cradle joint 150. For example, the top edge portion 146t may have a radius r4 such that a continuous surface engagement between the top edge portion 146t and the lower facing channel 151 is provided as depicted in FIG. 6. In some embodiments, radius r4 of the top edge portion 146t is generally equal to radius R4 of the lower facing channel 151, while in other embodiments radius r4 of the top edge portion 146t is less than radius R4 of the lower facing channel 151. It should be understood that the top edge portions 142t, 144t of the inlet end tile 142 and middle tile 144, respectively, may have radius r4 that is equal to the radius R4 of the lower facing channel 151, or in the alternative, is less than radius R4.

In embodiments, the top cradle joint 150 may provide a thermal separator between the plurality of top row tiles 140 and the top panel tiles 162, 164, 166. That is, the top cradle joint 150 physically and thermally separates the plurality of top row tiles 140 from the top panel tiles 162, 164, 166. In such embodiments, the top cradle joint 150 may be formed from a material that is different than a material from which the plurality of top row tiles 140 and/or the top panel tiles 162, 164, 166 are formed. In some embodiments, the top cradle joint 150 is formed from a material with a thermal conductivity that is greater than a thermal conductivity of the plurality of top row tiles 140 and/or a thermal conductivity of the top panel tiles 162, 164, 166. In other embodiments, the top cradle joint 150 is formed from a material with a thermal conductivity that is less than a thermal conductivity of the plurality of top row tiles 140 and/or a thermal conductivity of the top panel tiles 162, 164, 166.

The upper facing and lower facing channels of the cradle joints 110, 130, 150 provide versatility of tile selection used to form the side panels 100. Particularly, the upper facing and lower facing channels of the cradle joints 110, 130, 150 allow the side panels 100 to be formed from tiles with different thicknesses. In the alternative, or in addition to, the upper facing and lower facing channels of the cradle joints 110, 130, 150 allow the side panels 100 to be formed from tiles with different thermal conductivities. For example, the intermediate cradle joint 130 provides a versatile connection or joint between the plurality of bottom row tiles 120 and the plurality of top row tiles 140 such that the plurality of bottom row tiles 120 and the plurality of top row tiles 140 are not required to have the same thickness in order to fit and be positioned together to form the side panel 100. That is, the arcuate surfaces of the upper facing and lower facing channels of the cradle joints 110, 130, 150, and the complementary arcuate surfaces of the bottom edge portions and top edge portions of the bottom row tiles 120 and/or top row tiles 140, allow for tiles of different thicknesses to be positioned between and properly seated within the cradle joints 110, 130, 150. Accordingly, the cradle joints 110, 130, 150 provide versatility in side panel tile selection used to form the side panels 100. The upper facing and lower facing channels of the cradle joints 110, 130, 150 also allow tiles within a given row of tiles, i.e., tiles in the bottom row tiles 120 and/or tiles in the top row tiles 140, to have different thicknesses. For example, the middle tile 124 may have a thickness that is different than the thickness of the inlet end tile 122 and distal end tile 126, the middle tile 144 may have a thickness that is different than the thickness of the inlet end tile 142 and distal end tile 146, etc. In the alternative, or in addition to, the upper facing and lower facing channels of the cradle joints 110, 130, 150 allow tiles in the bottom row tiles 120 and/or tiles in the top row tiles 140 to have different thermal conductivities.

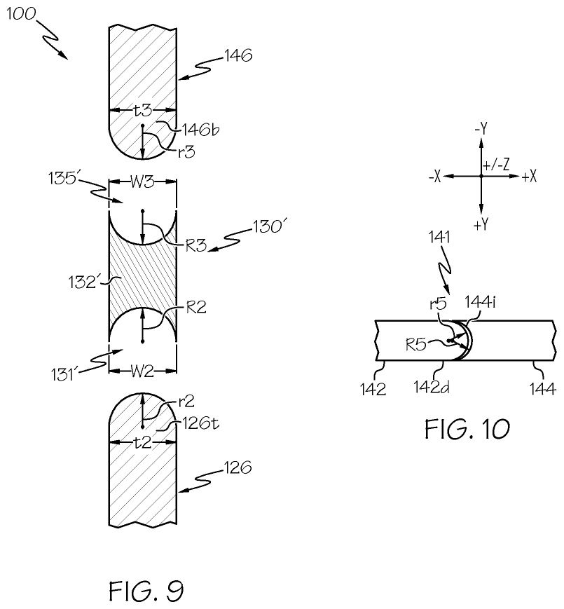

While FIGS. 6 and 7 depict the cradle joints with a thickness (Y direction) that is greater than a thickness of the panel tiles, in embodiments, the cradle joints may have a thickness that is generally equal to the thickness of the panel tiles. For example, FIG. 8 depicts one embodiment of an intermediate cradle joint 130′ with a thickness (Y direction) that is generally equal to the thickness of the distal end tiles 126, 146. FIG. 9 depicts an exploded view of the distal end tiles 126, 146 and intermediate cradle joint 130′ in FIG. 8. The intermediate cradle joint 130′ has a lower facing channel 131′ and an upper facing channel 135′ extending from a base 132′. The lower facing channel 131′ has the radius R2 and the width W2, and the upper facing channel 135′ has the radius R3 and the width W3. It should be appreciated that the bottom cradle joint 110 may have a thickness generally equal to one of the plurality of bottom row tiles 120. In the alternative, or in addition to, the top cradle joint 150 may have a thickness generally equal to one of the plurality of top row tiles 140. It should also be appreciated that other cradle joint channel and tile edge portion designs may be included. For example and without limitation, the channel and edge portion may have a tongue-and-groove design, a V-groove design, a truncated V-groove design, and the like.

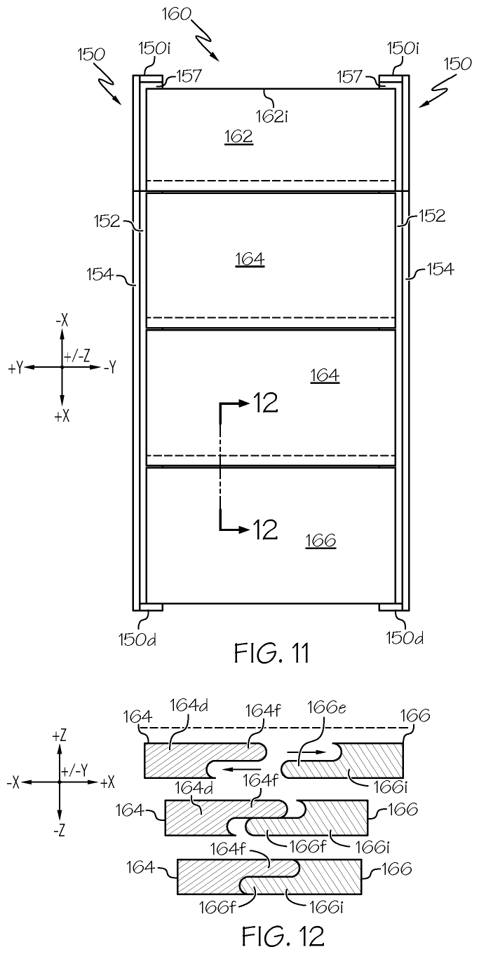

Referring back to FIG. 5, in embodiments, the bottom cradle joint 110, intermediate cradle joint 130, and top cradle joint 150 may have an inlet end lip 110i, 130i, 150i, respectively, and a distal end lip 110d, 130d, 150d, respectively. The inlet end lips 110i, 130i, 150i and the distal end lips 110d, 130d, 150d extend generally vertical (Z direction) from the bottom cradle joint 110, intermediate cradle joint 130, and top cradle joint 150, respectively. In embodiments, the inlet end lips 110i, 130i, 150i may have a channel (not shown) facing the distal end 104 of the side panel 100 (not shown) for inlet end sides 122i, 142i of the inlet end tiles 122, 142, respectively, to be seated within. Also, the distal end lips 110d, 130d, 150d may have a channel (not shown) facing the inlet end 102 of the side panel 100 for distal end sides 126d, 146d of distal end tiles 126, 146, respectively, to be seated within. For example, channels of the inlet end lips 110i, 130i, 150i and distal end lips 110d, 130d, 150d may be generally shaped like the upper facing channel 111 of the bottom cradle joint 110 (FIG. 7) and face towards the distal end 104 or inlet end 102 of the side panel 100. In such embodiments, the inlet end sides 122i, 142i of the inlet end tiles 122, 142, respectively, and the distal end sides 126d, 146d of the distal end tiles 126, 146, respectively, may have an arcuate shape that is complementary with the channels of the inlet end lips 110i, 130i, 150i and the channels of the distal end lips 110d, 130d, 150d, respectively. Also, an inlet end 162i (FIG. 11) of the inlet end tile 162 and the inlet end lip 150i may have a gap 157 there between such that expansion of the top panel tiles 162, 164, 166 generally along the length of the forming body 60 (X direction) does not result in a binding or compression force being generated within the top panel tiles 162, 164, 166, between the top panel tiles 162, 164, 166 and/or between the inlet end tile 162 and the inlet end lip 150i. The inlet end lips 110i, 130i, 150i and distal end lips 110d, 130d, 150d provide a stop for the inlet end tiles 122, 142 and distal end tiles 126, 146, respectively, to be positioned against during fabrication of the enclosure 90 thereby ensuring proper alignment and positioning of the bottom row tiles 120 and top row tiles 140.

Referring now to FIG. 10, a cross-sectional view of a convex-concave overlapping joint 141 between the inlet end tile 142 and the adjacent middle tile 144 is depicted. Particularly, the inlet end tile 142 has a distal side edge 142d and the middle tile 144 has an inlet side edge 144i. The distal side edge 142d of the inlet end tile 142 has a convex arcuate shape that is complementary with a concave arcuate shape of the inlet side edge 144i of the middle tile 144 such that an overlapping joint with a continuous surface engagement is provided between the inlet end tile 142 and middle tile 144. In embodiments, the distal side edge 142d has a radius r5 and the inlet side edge 144i has a radius R5. In such embodiments, radius r5 of the distal side edge 142d may be generally equal to radius R5 of the inlet side edge 144i, or in the alternative, radius r5 may be less than radius R5. It should be understood that a convex-concave overlapping joint may be present between all adjacent tiles that form the side panel 100. Particularly, a convex-concave overlapping joint may be provided between a distal end side of the inlet end tile 122 and the inlet end side of middle tile 124; the distal end side of middle tile 124 and the inlet end side of distal end tile 126; and the distal end side of middle tile 144 and the inlet end side of distal end tile 146. The convex-concave overlapping joint 141 provides a heat convection and heat radiation seal between an interior and an exterior of the enclosure 90. In embodiments, the convex-concave overlapping joint 141 does not have a discontinuous surface, sharp edge or joint design (e.g., a tongue-in- groove joint) that is prone to fracture during thermal expansion, thermal contraction and/or misalignment of adjacent side panel tiles. Such an improved overlapping joint reduces cracking of side panel tiles caused by thermal gradients and/or thermal cycling during a glass ribbon forming campaign run.

Referring now to FIG. 11, a top view of the top panel 160 with inlet end tile 162, distal end tile 166 and two middle tiles 164 is depicted. The top panel tiles 162, 164, 166 are positioned above and supported by the base 152 (FIG. 7) of the top cradle joint 150. The outer wall 154 extending upwardly (+Z direction) from the base 152 provides a stop to align and position the top panel tiles 162, 164, 166 on the top cradle joint 150 and may serve as a radiation shield in the event a separation occurs between one or more of the top panel tiles 162, 164, 166 and the base 152 of the top cradle joint 150. In embodiments, the top panel tiles 162, 164, 166 are positioned between the inlet end lip 150i and distal end lip 150d of the top cradle joint 150 and the inlet end lip 150i may be spaced apart from the inlet end 162i of the inlet end tile 162 to provide the gap 157 there between. The gap 157 provides space or room for the top panel tiles 162, 164, 166 to expand along the length of the top panel 160 (−X direction) without the inlet end 162i of the inlet end tile 162 come into contact with the inlet end lip 150i. Accordingly, stress within and between the top panel tiles 162, 164, 166 is reduced or avoided.

Referring now to FIG. 12, in embodiments, adjacent edge portions of the inlet end tile 162, middle tiles 164 and distal end tile 166 may have half-lap splice joints there between. Particularly, a distal end 164d of the middle tile 164 has an overlapping finger 164f extending towards the distal end (+X direction) of the side panel 100 and an inlet end 166i of the distal end tile 166 has an overlapping finger 166f extending towards the inlet end (−X direction) of the side panel 100. The overlapping finger 164f extends from an upper (+Z direction) thickness portion (not labeled) of the distal end 164d and the overlapping finger 166f extends from a lower (−Z direction) thickness portion (not labeled) of the inlet end 166i such that the overlapping fingers 162f, 164f are positioned above/below each other and form an overlapping joint as depicted in FIG. 12. It should be appreciated that adjacent edges between the middle tiles 164 and adjacent edges between the middle tile 164 and inlet end tile 162 may include overlapping fingers that provide overlapping joints between the adjacent tiles. The overlapping joint depicted in FIG. 12 provides a heat convection and heat radiation seal between the interior and exterior of the enclosure 90 yet allows movement between adjacent tiles, such as movement due to thermal expansion and contraction, without binding and creating stress between adjacent top panel tiles 162, 164, 166.

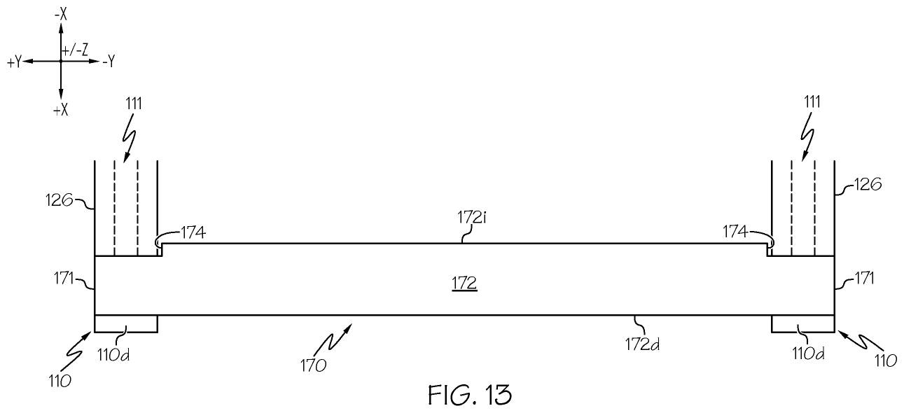

Referring now to FIG. 13, an embodiment of a top cross-section of the distal end panel 170 (FIG. 4) is depicted. The distal end panel 170 may include a distal end panel tile 172 with a pair of ends 171, an inlet end side 172i and a distal end side 172d. The distal end panel tile 172 may be positioned on and supported by the bottom cradle joints 110 and the ends 171 may each have a shoulder 174 extending along the height (Z direction) of the ends 171 such that the distal end panel tile 172 is inset within the distal end tiles 126 of the plurality of bottom row tiles 120 and distal end tiles 146 of the plurality of top row tiles 140 (not shown in FIG. 13). It should be understood that molten glass does not flow out of the trough 61 at the distal end of the forming body 60 and the region proximate the distal end panel 170 (FIG. 4). It should also be understood that thermal control of the distal end of the forming body 60 within the enclosure 90 may not be as important as thermal control of the region where molten glass flows out of the trough 61 and down the outer vertical surfaces 108, 109 and forming surfaces 62, 64. Accordingly, in embodiments, the distal end panel 170 may be formed from a single distal end panel tile 172 extending from the top panel 160 to the bottom cradle joint 110. In other embodiments, the distal end panel 170 may be formed from a plurality of distal end panel tiles (not shown) and include a distal end bottom cradle joint (not shown), distal end top cradle joint (not shown) and a distal end intermediate cradle joint (not shown) positioned between the distal end bottom cradle joint and distal end top cradle joint, as described hereinabove with respect to FIGS. 4 and 5. In such embodiments, the plurality of distal end panel tiles, distal end bottom cradle joint, distal end intermediate cradle joint and distal end top cradle joint may have the same physical dimensions and/or dimensional cooperating characteristics and discussed above for the bottom row tiles 120, top row tiles 140, bottom cradle joint 110, intermediate cradle joint 130 and top cradle joint 150.

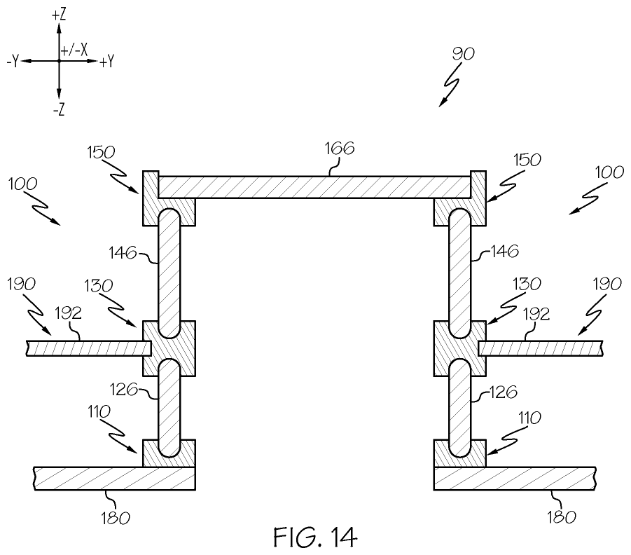

Referring now to FIG. 14, in embodiments, the enclosure 90 may include an intermediate support 190 in addition to the base support 180. The intermediate support 190 extends from the intermediate cradle joint 130 and assists in supporting the weight of the enclosure 90. The intermediate support 190 may include a support arm 192 attached to an exterior support structure (not shown). In the alternative, or in addition to, the intermediate support 190 may include a hanger (not shown) suspended from a top support (not shown) and extending to the support arm 192. The support arm 192 supports at least a portion of the weight of the side panels 100 and top panel 160 thereby reducing the load support requirements of the bottom row tiles 120. As noted above, as enclosures for forming bodies increase in size, the size (length and height), thickness and weight of refractory tiles used to form the enclosure also increase in size. As refractory tiles increase in size and thickness, thermal expansion, thermal contraction and cracking of the tiles due to thermal gradients and thermal cycling, which can occur during the glass ribbon forming process, may increase. Cracking of the tiles may result in thermal discontinuities within the molten glass flowing over the forming surfaces of the forming body thereby resulting in glass ribbon that is out of specification and must be discarded. The intermediate support 190 extending from the intermediate cradle joint 130 assists in supporting the weight of the enclosure 90 thereby allowing the side panels 100 to be formed with tiles having reduced thicknesses. For example, the intermediate support 190 supports at least part of the weight of the top panel 160 and top row tiles 140 such that the thickness of the plurality of bottom row tiles 120 may be reduced while structural support and alignment of the plurality of top row tiles 140 is provided. Accordingly, the plurality of bottom row tiles 120 may have a first thickness and the plurality of top row tiles 140 may have a second thickness different than the first thickness. For example, the plurality of top row tiles 140 may have a second thickness that is greater than the first thickness of the bottom row tiles 120. Also, the thickness of the plurality of bottom row tiles and the thickness of the plurality of top row tiles may be reduced compared to current tile thicknesses used to form forming body enclosures. In some embodiments, the thickness of the plurality of bottom row tiles 120 and/or the plurality of top row tiles 140 may be reduced by more than 25%, for example by more than 30%, compared to current tile thicknesses used to form forming body enclosures.

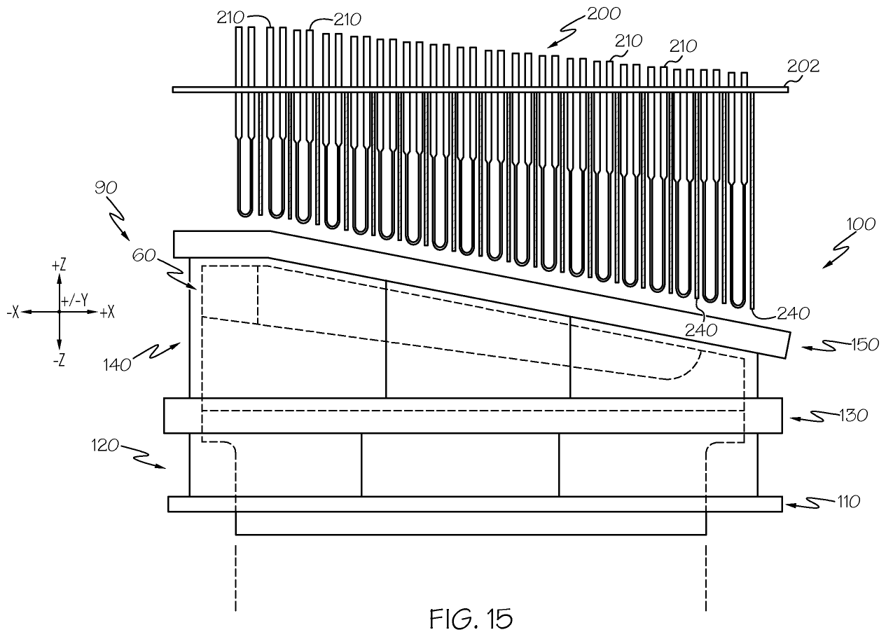

Referring now to FIG. 15, in embodiments, the enclosure 90 may be used with an array of thermal elements 200 extending along at least a portion of, or the entire, length L of the forming body 60. For example, in embodiments, the array of thermal elements 200 may include a plurality of heating elements 210 that are suspended from a support 202 and extend from the support 202 to a position above the enclosure 90. The array of thermal elements 200 may also extend along a width of the forming body 60. It is understood that the enclosure 90 prevents debris from the array of thermal elements 200, such as debris from blistering or scaling of a heating element 210, from falling into the molten glass within the trough 61 and/or adhering to molten glass flowing down the outer vertical surfaces 108, 109. Accordingly, the enclosure 90 aids in reducing contamination of the molten glass and the top panel 160 provides thermal diffusion between the heating elements 210 and molten glass such that discreet temperature and viscosity differences in the molten glass are avoided. In some embodiments the array of thermal elements 200 may include a cooling element (not shown). Also, one or more of the heating elements 210 may extend vertically (+/−Z direction) along the side panels 100 of the enclosure 90 (not shown). In such embodiments, it is understood that the enclosure 90 aids in preventing debris from a side heating element 210, such as debris from blistering or scaling of a side heating element 210, from contaminating the molten glass flowing down (−Z direction) the outer vertical surfaces 108, 109. Also, the side panels 100 provide thermal diffusion between the side heating elements 210 and the molten glass such that discreet temperature and viscosity differences in the molten glass are avoided. In some embodiments, the array of thermal elements 200 includes thermal shields 240 positioned between adjacent heating elements 210 as depicted in FIG. 15. The thermal shields 240 provide radiation heat control and enhance localization of the heating and/or cooling provided by adjacent heating elements 210.

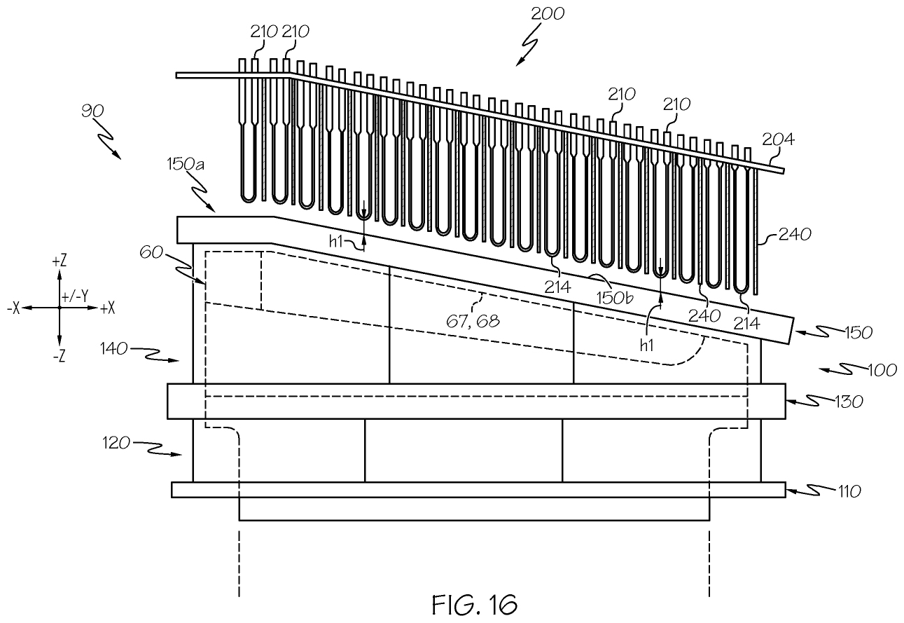

Referring now to FIG. 16, the array of thermal elements 200 may be suspended from a support plate 204 positioned above (+Z direction) and extending substantially parallel to and across the top panel 160 and thus the top surfaces of the first and second weirs 67, 68 of the trough 61. As depicted in FIG. 16, the first weir and the second weir may extend from the inlet end of the trough 61 at an incline relative to horizontal (X axis) as does the top panel 160. As used herein, the term “incline” refers to an angle not equal to 0. Accordingly, the top cradle joint 150 may include the first portion 150a and the second portion 150b, middle tiles 164 and distal end tile 166 that extend at an incline relative to horizontal (X axis) at an angle greater than or equal to 2 degrees with respect to horizontal. With the support plate 204 positioned above and extending substantially parallel to and across the top panel 160, the plurality of heating elements 210 positioned along the length L of the forming body 60 may be of uniform size, i.e., uniform in length (Z-direction), with bottom portions 214 positioned a distance hi that is equidistant from the top panel 160 along the length L of the forming body 60. In embodiments, thermal shields 240 may be positioned between adjacent heating elements 210. Specifically, the thermal shields 240 may be positioned between adjacent heating elements 210 along the length L of the forming body 60, between adjacent heating elements 210 along the width W of the forming body 60 or between adjacent heating elements 210 along both the length L and the width W of the forming body 60. The thermal shields 240 provide radiation heat control and enhanced localization of the heating and/or cooling provided by adjacent heating elements 210.

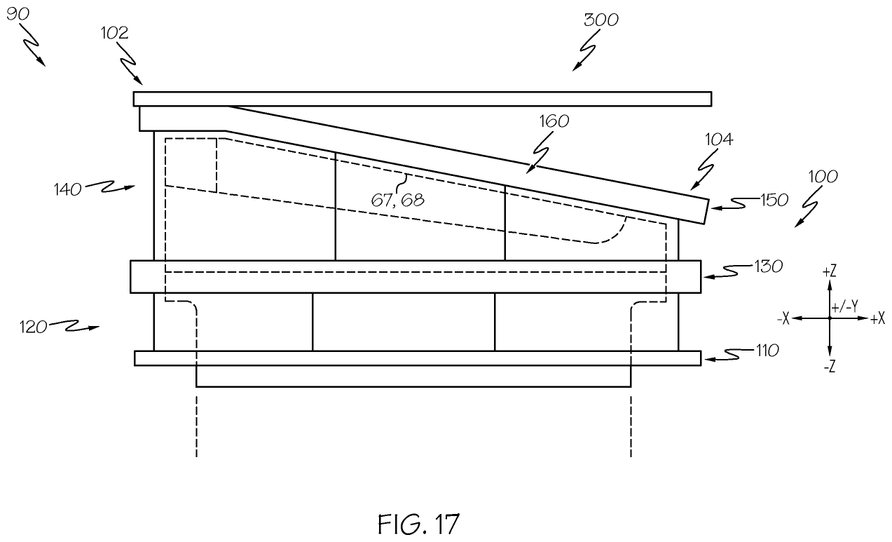

Referring now to FIG. 17, in embodiments, a heating element 300 extends along at least a portion of the length L of the forming body 60, such as, for example, the entire length. The heating element 300 is a generally linear heating element. In embodiments, at least one heating element 300 extends generally from the inlet end 102 to the distal end 104 of the side panel 100 and over the first and second weirs 67, 68 of the trough 61 or along and adjacent to one of the outer vertical surfaces 108, 109 (FIG. 3). It is appreciated that the heating element 300 may be positioned substantially parallel to the root 70 of the forming body 60. Alternatively, or in addition, the heating element 300 may be positioned substantially parallel to the top panel 160 of the enclosure 90 extending over the trough 61.

Suitable materials from which the bottom row tiles 120, top row tiles 140, top panel tiles 162, 164, 166 are formed are materials with high thermal conductivity, high emissivity and high heat resistance, illustratively including, without limitation, SiC and SiN. Suitable materials from which the cradle joints 110, 130, 150 are formed may be the same as the material from which the bottom row tiles 120, top row tiles 140, top panel tiles 162, 164, 166 are formed, e.g., SiC and SiN. In the alternative, one or more of the cradle joints 110, 130, 150 may be formed from a material that is different than the from which the bottom row tiles 120, top row tiles 140, top panel tiles 162, 164, 166 are formed, illustratively including, without limitation, alumina, mullite, and other high temperature ceramics.

Suitable materials from which the base support 180 and intermediate support 190 are formed are materials with high heat resistance, illustratively including, without limitation, steels, stainless steels, and Ni-base alloys.

It should be understood that the cradle joints 110, 130, 150 allow for tiles with different thicknesses and thermal conductivities to be selected and used for fabrication of the enclosure 90. The versatility in tile selection may provide distinct thermal profiles for the molten glass flowing over the outer vertical surfaces 108,109 and the forming surfaces 62, 64. For example, thermal profiles along the molten glass flow direction (−Z direction) over the outer vertical surfaces 108, 109 and forming surfaces 62, 64 of the forming body may be altered by changing the location of the intermediate cradle joint 130 along the height (Z direction) of the side panels 100. Also, zoned temperature control along the length of the trough 61 may be improved by changing tile material along the plurality of bottom row tiles 120 and/or the plurality of top row tiles 140. For example, inlet end tiles 122, 142 and distal end tiles 126, 146 may have a first thermal conductivity and the middle tiles 124, 144 may have a second thermal conductivity that is less than the first thermal conductivity such that a faster thermal response is provided for molten glass at the inlet end 52 and distal end 58 of the trough 61 compared to a center portion of the trough 61.

The cradle joints 110, 130, 150, with and without the intermediate support 190, also allow tiles with a reduced thickness and weight to be used to form the enclosure 90. In the alternative, or in addition to, tiles with a reduced thickness and larger size (height and/or width) may be used to form the side panels 100 which may lead to reduced cracking of the tiles. For example, tiles with a width greater than a height reduce point contact and stress concentration between adjacent tiles due to tile rotation motion caused by sliding expansion.

Joint design between adjacent tiles, and between the tiles and cradle joints, may mitigate cracking of tiles due to accumulation of mechanical stress resulting from thermal expansion thereby reducing thermal leakage from the enclosure 90. For example, the convex-concave overlapping joint (FIG. 10) reduces stress concentrations between adjacent side panel tiles due to smooth surface engagement there between while providing a heat convection and heat radiation seal between the interior and exterior of the enclosure 90. The half-lap splice joints (FIG. 12) between the top panel tiles 162, 164, 166 160 accommodate expansion and contraction between adjacent top panel tiles while maintaining an overlapping seal between the interior and exterior of the enclosure 90. The half-lap splice joints in combination with the gap 157 between the inlet end 162i of the inlet end tile 162 and the inlet end lip 150i of the top cradle joint 150 accommodates expansion of the top panel tiles 162, 164, 166 toward the inlet end 102 of the side panel 100. Also, the inlet end lips 110i, 130i, 150i and distal end lips 110d, 130d, 150d provide a radiation shield if the inlet end tiles 122, 142 and/or distal end tiles 126, 146 expand, contract or shift such that a gap between the inlet end tiles 122, 142 and/or distal end tiles 126, 146 and the cradle joints develops proximal the inlet end 102 and/or distal end 104 of the side panel 100. Reduced fabrication costs of side panel tiles may be achieved due to the reduced complexity of the joint designs (e.g., compared to a tongue and groove joint design) and reduced tile thickness. Rebuild costs of an enclosure 90 may also be reduced through the use of recycled cradle joints.

Based on the foregoing, it should now be understood that enclosures for forming bodies described herein can be used to improve thermal management of molten glass during a glass ribbon forming campaign. The use of enclosures with cradle joints as described herein allows for side panel tiles with reduced thicknesses, made from different materials with different thermal conductivities and the like to be used in order to reduce cost, improve fabrication thereof, reduce cracking of the tiles due to thermal cycling, and the like. The use of the cradle joints also allows for additional support of the enclosure, for example through the use of an intermediate support to assist in supporting the weight thereof

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A glass forming apparatus comprising:
a forming body; and
an enclosure positioned around the forming body and comprising a top panel and a pair of side panels, each side panel of the pair of side panels comprising:
a plurality of cradle joints, a plurality of bottom row tiles and a plurality of top row tiles, wherein:
the plurality of cradle joints extend along a length of the forming body;
the plurality of top row tiles are positioned above the plurality of bottom row tiles with at least one of the plurality of cradle joints positioned between the plurality of bottom row tiles and plurality of top row tiles; and
the plurality of top row tiles and the plurality of bottom row tiles are engaged with the at least one of the plurality of cradle joints to form each of the pair of side panels.

2. The glass forming apparatus of claim 1, wherein the plurality of cradle joints comprise a bottom cradle joint, an intermediate cradle joint and a top cradle joint each extending along the length of the forming body, wherein the intermediate cradle joint is spaced apart from and positioned above the bottom cradle joint, and the top cradle joint is spaced apart from and positioned above the intermediate cradle joint.

3. The glass forming apparatus of claim 2, wherein the plurality of bottom row tiles extend between the bottom cradle joint and intermediate cradle joint, and the plurality of top row tiles extend between the intermediate cradle joint and the top cradle joint, wherein a bottom edge portion and a top edge portion of each of the plurality of bottom row tiles is seated within the bottom cradle joint and intermediate cradle joint, respectively, and a bottom edge portion and a top edge portion of each of the plurality of top row tiles is seated within the intermediate cradle joint and top cradle joint, respectively.

4. The glass forming apparatus of claim 2, wherein the bottom cradle joint comprises a U-shaped elongated member with an upper facing channel and a bottom edge portion of each of the plurality of bottom row tiles is seated within the upper facing channel of the bottom cradle joint.

5. The glass forming apparatus of claim 2, wherein:
the intermediate cradle joint comprises an H-shaped elongated member with a lower facing channel and an upper facing channel; and
a top edge portion of each of the plurality of bottom row tiles is seated within the lower facing channel of the intermediate cradle joint and a bottom edge portion of each of the plurality of top row tiles is seated within the upper facing channel of the intermediate cradle joint.

6. The glass forming apparatus of claim 2, wherein the top cradle joint comprises an h-shaped elongated member with a lower facing channel and a top edge portion of each of the plurality of top row tiles is seated within the lower facing channel of the top cradle joint.

7. The glass forming apparatus of claim 2, wherein each of the bottom cradle joints, intermediate cradle joints and top cradle joints comprise an inlet end with an inlet end lip and a distal end with a distal end lip.

8. The glass forming apparatus of claim 1, wherein the plurality of bottom row tiles comprise a first thickness and the plurality of top row tiles comprise a second thickness that is different than the first thickness.

9. The glass forming apparatus of claim 1, wherein the plurality of bottom row tiles comprise an inlet end tile, a distal end tile and at least one middle tile positioned between the inlet end tile and distal end tile, and a thickness of the at least one middle tile positioned between the inlet end tile and distal end tile is different than a thickness of at least one of the inlet end tile and distal end tile.

10. The glass forming apparatus of claim 1, wherein the top panel comprises a plurality of top panel tiles extending between the pair of side panels along the length of the forming body, wherein adjacent edges of the plurality of top panel tiles comprise a half-lap splice joint.

11. The glass forming apparatus of claim 1, further comprising a distal end panel extending between a distal end of each of the pair of side panels.

12. An enclosure for a forming body of a glass forming apparatus comprising:
a pair of side panels and a top panel extending between the pair of side panels, wherein each of the pair of side panels comprises:
a bottom cradle joint, an intermediate cradle joint and a top cradle joint, wherein the intermediate cradle joint is spaced apart from and positioned above the bottom cradle joint, and the top cradle joint is spaced apart from and positioned above the intermediate cradle joint; and
a plurality of bottom row tiles extending between the bottom cradle joint and the intermediate cradle joint, and a plurality of top row tiles extending between the intermediate cradle joint and the top cradle joint, wherein a bottom edge portion and a top edge portion of each of the plurality of bottom row tiles is seated within the bottom cradle joint and the intermediate cradle joint, respectively, and a bottom edge portion and a top edge portion of each of the plurality of top row tiles is seated within the intermediate cradle joint and the top cradle joint, respectively.

13. The enclosure of claim 12, wherein the bottom cradle joint comprises a U-shaped elongated member with an upper facing channel and the bottom edge portion of each of the plurality of bottom row tiles is seated within the upper facing channel of the bottom cradle joint.

14. The enclosure of claim 12, wherein:
the intermediate cradle joint comprises an H-shaped elongated member with a lower facing channel and an upper facing channel; and
the top edge portion of each of the plurality of bottom row tiles is seated within the lower facing channel of the intermediate cradle joint and the bottom edge portion of each of the plurality of top row tiles is seated within the upper facing channel of the intermediate cradle joint.

15. The enclosure of claim 12, wherein the top cradle joint comprises an h- shaped elongated member with a lower facing channel and the top edge portion of each of the plurality of top row tiles is seated within the lower facing channel.

16. The enclosure of claim 12, wherein adjacent side edges of the plurality of bottom row tiles and the plurality of top row tiles comprise a convex-concave overlapping joint.

17. The enclosure of claim 12, wherein the top panel comprises a plurality of top panel tiles extending between the pair of top cradle joints, wherein adjacent edges of the plurality of top panel tiles comprise a half-lap splice joint.

18. A glass forming apparatus comprising:
a forming body positioned within an enclosure;
the enclosure extending along a length of the forming body and comprising a pair of side panels and a top panel extending between the pair of side panels, wherein each of the pair of side panels comprises:
a bottom cradle joint comprising a U-shaped elongated member with an upper facing channel, an intermediate cradle joint comprising an H-shaped elongated member with a lower facing channel and an upper facing channel, and a top cradle joint comprising an h-shaped elongated member with a lower facing channel, wherein the intermediate cradle joint is spaced apart from and positioned above the bottom cradle joint, and the top cradle joint is spaced apart from and positioned above the intermediate cradle joint; and
a plurality of bottom row tiles extending between and seated within the upper facing channel of the bottom cradle joint and lower facing channel of the intermediate cradle joint, and a plurality of top row tiles extending between and seated within the upper facing channel of the intermediate cradle joint and the lower facing channel of the top cradle joint.

19. The glass forming apparatus of claim 18, wherein each of the bottom cradle joints, intermediate cradle joints and top cradle joints comprise an inlet end with an inlet end lip and a distal end with a distal end lip.

20. The glass forming apparatus of claim 18, wherein adjacent side edges of the plurality of bottom row tiles and plurality of top row tiles comprise a convex-concave overlapping joint.
